(19) United States
(12) Patent Application Publication
(10) Pub. No.: US 2014/0305199 A1
(43) Pub. Date: Oct. 16, 2014

(54) SYSTEM FOR MONITORING TIRE PRESSURES OF A PLURALITY OF WHEELS OF A MOTOR VEHICLE AND PRESSURE MONITORING METHOD

(71) Applicant: Johnson Controls Automotive Electronics SAS, Stuttgart (DE)

(72) Inventors: Serge Hernando, Cergy (FR); Christian Noel, Herblay (FR); Thierry Pinard, Garches (FR)

(73) Assignee: Johnson Controls Automotive Electronics SAS, Stuttgart (DE)

(21) Appl. No.: 14/355,185

(22) PCT Filed: Oct. 31, 2012
(86) PCT No.: PCT/EP2012/071634

§ 371 Date: Apr. 29, 2014

(30) Foreign Application Priority Data
Oct. 31, 2011 (FR) 11 03312

(51) Int. Cl. B60C 23/04; G01M 17/02

(52) U.S. Cl. CPC B60C 23/04; G01M 17/02
USPC 73/146

(57) ABSTRACT

A system for monitoring the pressure in the tires of a plurality of wheels of a motor vehicle comprises a first sensor module that comprises at least one sensor measuring the angular velocity of at least part of the plurality of wheels of the motor vehicle. A means is provided for determining, from the angular velocity of at least part of the plurality of wheels of the motor vehicle, a signal indicative of a first value of the heading of the motor vehicle. A second sensor module generates a signal indicative of a second value of the heading of the motor vehicle, and an abnormal situation with the pressure in at least one of the tires is determined when the first value of the heading of the motor vehicle and the second value of the heading of the motor vehicle are not consistent with one another.

### BACKGROUND

The present invention relates to a system for monitoring the pressure in the tires of a plurality of wheels of a motor vehicle, and a method for monitoring the pressure in the tires of a plurality of wheels of a motor vehicle.

In order to ensure the safety and the comfort of the driver of a motor vehicle, it is essential to know and monitor the pressure of the tires of the vehicle. Simply, reliably and regularly informing the driver as to the level of inflation of the tires of his or her vehicle contributes to improving its safety and consumption, to prolonging the life of the tires, and so on. Such systems generally comprise at least one pressure sensor of a type that is known per se.

Methods for monitoring the pressure of the tires of a vehicle are known, which inform the driver or the warning system of the vehicle of a situation of underinflation of at least one of the tires of the vehicle. Such systems normally require a pressure sensor in or on or associated with each wheel of the motor vehicle, therefore normally at least four pressure sensors.

### SUMMARY

The aim of the present invention is notably to mitigate the drawbacks of the prior art, and in particular those cited above, and also to propose a system for monitoring the pressure in the tires of a plurality of wheels of a motor vehicle, as well as a method for monitoring the pressure in the tires of a plurality of wheels of a motor vehicle which is both accurate and which can be produced at low cost.

According to the present invention, this aim is achieved through a system for monitoring the pressure in the tires of a plurality of wheels of a motor vehicle,

the monitoring system comprising a first sensor module, the first sensor module comprising at least one sensor measuring the angular velocity of at least a part of the plurality of wheels of the motor vehicle,

the monitoring system comprising a computation means for determining, from the angular velocity of at least a part of the plurality of wheels of the motor vehicle, a signal indicative of a first value of the heading of the motor vehicle, characterized in that
the monitoring system also comprises a second sensor module generating a signal indicative of a second value of the heading of the motor vehicle,
and that
an abnormal pressure situation in at least one of the tires of the plurality of wheels of the motor vehicle is determined when the first value of the heading of the motor vehicle and the second value of the heading of the motor vehicle are inconsistent.

By producing the monitoring system in such a way, it is advantageously possible according to the present invention to produce an accurate measurement without the need—at least in most cases—for additional elements, because, in most motor vehicles, there are not only ABS sensors (anti-lock braking system sensors), which determine the angular velocity of the wheels of the motor vehicle, but also sensors for determining the heading of the motor vehicle.

A preferred refinement of the invention lies in the fact that the second sensor module, generating a signal indicative of the second value of the heading of the motor vehicle, comprises or is associated with a satellite positioning location interface.

Yet another preferred refinement of the invention lies in the fact that the second sensor module, generating a signal indicative of the second value of the heading of the motor vehicle, comprises or is associated with a compass module.

By producing a monitoring system in such ways, it is advantageously possible to use the location information obtained by a satellite positioning location interface and/or by a compass module.

A particularly preferred refinement of the invention lies in the fact that the monitoring system also comprises a pressure sensor in a predetermined wheel or associated with a predetermined wheel of the plurality of wheels of the motor vehicle for transmitting information indicative of the value of the instantaneous pressure in the tire of the predetermined wheel, and that an abnormal pressure situation in at least one of the tires of the plurality of wheels of the motor vehicle is determined, by dependency of the value of the instantaneous pressure in the tire of the predetermined wheel, when the first value of the heading of the motor vehicle and the second value of the heading of the motor vehicle are inconsistent.

By producing the monitoring system in such a way, it is advantageously possible according to the present invention to increase the accuracy of the determination of the pressure in the tires of the wheels of the motor vehicle without the need to provide a pressure sensor in or associated with each wheel of the plurality of wheels of the motor vehicle.

Moreover, the present invention also relates to a method for monitoring the pressure in the tires of a plurality of wheels of a motor vehicle by using a pressure monitoring system,

the monitoring system comprising a first sensor module, the first sensor module comprising at least one sensor measuring the angular velocity of at least a part of the plurality of wheels of the motor vehicle,

the monitoring system comprising a computation means for determining, from the angular velocity of at least a part of the plurality of wheels of the motor vehicle, a signal indicative of a first value of the heading of the motor vehicle,
characterized in that
the monitoring system also comprises a second sensor module generating a signal indicative of a second value of the heading of the motor vehicle,
and that the pressure monitoring method comprises the following steps:

a first step of determining the first value of the heading of the motor vehicle and the second value of the heading of the motor vehicle, and

a second step of determining an abnormal pressure situation in at least one of the tires of the plurality of wheels of the motor vehicle when the first value of the heading and the second value of the heading are inconsistent.

Also in relation to the method for monitoring the pressure in the tires of a plurality of wheels, it is preferred, according to the present invention

that the second sensor module, generating a signal indicative of the second value of the heading of the motor vehicle, comprises or is associated with a satellite positioning location interface,

that the second sensor module, generating a signal indicative of the second value of the heading of the motor vehicle, comprises or is associated with a compass module, and

that the monitoring system also comprises a pressure sensor in a predetermined wheel or associated with a predetermined wheel of the plurality of wheels of the motor vehicle for transmitting information indicative of the value of the instantaneous pressure in the tire of the predetermined wheel, and that, during the first step of the monitoring method, the value of the instantaneous pressure in the tire of the predetermined wheel is determined.

Other features and advantages of the invention will emerge from reading the following description of a nonlimiting particular embodiment of the present invention.

### DRAWINGS

The invention will be better understood from the following description, which relates to preferred embodiments, given as nonlimiting examples and explained with reference to the attached schematic drawing, in which:

FIG. 1 a schematic view of a flow diagram of the monitoring method according to the present invention.

### DETAILED DESCRIPTION

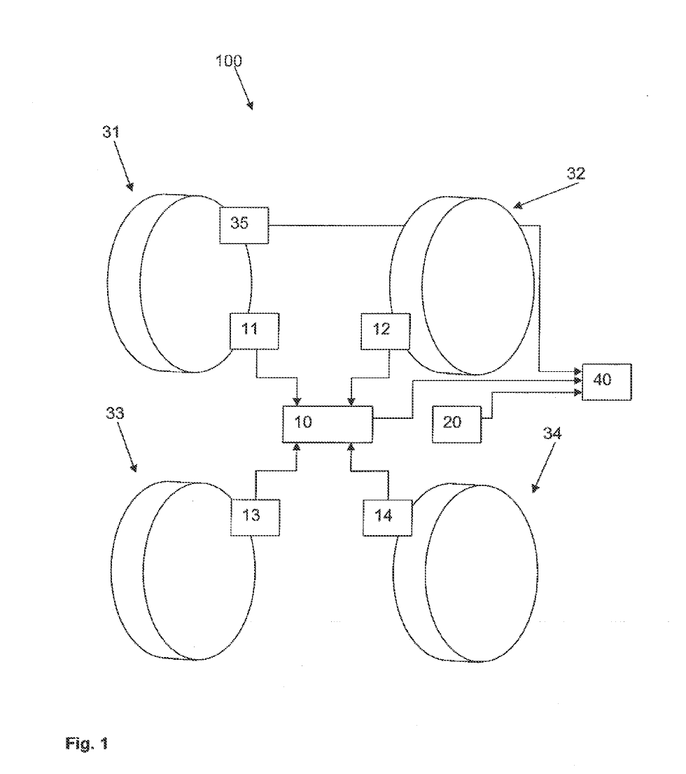

As FIG. 1 of the attached drawing shows, a system for monitoring 100 the pressure in the tires of a plurality of wheels 31, 32, 33, 34 of a motor vehicle comprises a first sensor module 10. The first sensor module 10 is provided to measure the angular velocity of at least a part of the plurality of wheels 31, 32, 33, 34 of the motor vehicle. The first sensor module 10 is notably provided as ABS (anti-lock braking system) sensor of the motor vehicle. Preferably, the first sensor module 10 comprises, for example, a sensor for each wheel for measuring the angular velocity of the wheel. In the example of FIG. 1, the motor vehicle comprises four wheels 31, 32, 33, 34 and the first sensor module 10 is associated with four different sensors 11, 12, 13, 14, one sensor 11, 12, 13, 14 for each wheel 31, 32, 33, 34.

The sensors 11, 12, 13, 14 supply, to the first sensor module 10, signals indicative of the angular velocity of the respectively associated wheel 31, 32, 33, 34. The pressure monitoring system 100 comprises a computation means 40. The computation means 40 is provided to determine, from the angular velocity of at least a part of the plurality of wheels 31, 32, 33, 34 of the motor vehicle—obtained by the first sensor module 10—a signal indicative of a first value of the heading of the motor vehicle.

According to the present invention, the monitoring system 100 also comprising a second sensor module 20 generating a signal indicative of a second value of the heading of the motor vehicle. The second sensor module 20 is notably provided as satellite positioning location interface of the motor vehicle or even as compass module.

The second value of the heading of the motor vehicle, obtained from the second sensor module 20, is also supplied to the computation means 40.

In the computation means 40, notably a microprocessor, the first and second values of the heading of the motor vehicle are compared. In normal situations, that is to say when the pressure in all the wheels 31, 32, 33, 34 of the motor vehicle is sufficiently high, the first heading value of the motor vehicle and the second heading value of the motor vehicle are consistent with one another, notably comparable.

In the event of an abnormal pressure situation in at least one of the tires of the wheels 31, 32, 33, 34 of the motor vehicle, the wheel concerned will have an increased angular velocity (compared to the situation when the tire is inflated), and, consequently, the first heading value which is computed as a function of the angular velocity of the wheel, will indicate a direction of the motor vehicle which is inconsistent with the second heading value derived from the signals from the second sensor module 20.

In a first embodiment of the pressure monitoring system 100 according to the present invention, the first sensor module 10 and the second sensor module 20 are used to determine the state of the pressure in the tires of the plurality of wheels 31, 32, 33, 34 of the motor vehicle. In the first embodiment of the monitoring system 100, the signals obtained from the first sensor module 10 and from the second sensor module 20 are used to determine the state of the pressure in the tires of the plurality of wheels 31, 32, 33, 34 of the motor vehicle.

In a second embodiment of the pressure monitoring system 100 according to the present invention, a pressure sensor 35 is added to the first sensor module 10 and to the second sensor module 20. The pressure sensor 35 is positioned in a predetermined wheel 31 (of the plurality of wheels 31, 32, 33, 34 of the motor vehicle) or associated with a predetermined wheel 31. In the second embodiment of the monitoring system 100, the signals obtained from the first sensor module 10, from the second sensor module 20 and from the pressure sensor 35 are used to determine the state of the pressure in the tires of the plurality of wheels 31, 32, 33, 34 of the motor vehicle.

1. A system for monitoring the pressure in the tires of a plurality of wheels of a motor vehicle, comprising:
a first sensor module comprising at least one sensor measuring the angular velocity of at least a part of the plurality of wheels of the motor vehicle, and
a computation means for determining, from the angular velocity of at least a part of the plurality of wheels of the motor vehicle, a signal indicative of a first value of the heading of the motor vehicle,
a second sensor module generating a signal indicative of a second value of the heading of the motor vehicle,
wherein an abnormal pressure situation in at least one of the tires of the plurality of wheels of the motor vehicle is determined when the first value of the heading of the motor vehicle and the second value of the heading of the motor vehicle are inconsistent.

2. The monitoring system as claimed in claim 1, wherein the second sensor module, generating a signal indicative of the second value of the heading of the motor vehicle, comprises or is associated with a satellite positioning location interface.

3. The monitoring system as claimed in claim 1, wherein the second sensor module, generating a signal indicative of the second value of the heading of the motor vehicle, comprises or is associated with a compass module.

4. The monitoring system as claimed in claim 1, wherein the monitoring system also comprises a pressure sensor in a predetermined wheel or associated with a predetermined wheel of the plurality of wheels of the motor vehicle for transmitting information indicative of the value of the instantaneous pressure in the tire of the predetermined wheel, and wherein an abnormal pressure situation in at least one of the tires of the plurality of wheels of the motor vehicle is determined, by dependency of the value of the instantaneous pressure in the tire of the predetermined wheel, when the first value of the heading of the motor vehicle and the second value of the heading of the motor vehicle are inconsistent.

5. A method for monitoring the pressure in the tires of a plurality of wheels of a motor vehicle by using a pressure monitoring system comprising a first sensor module comprising at least one sensor measuring the angular velocity of at least a part of the plurality of wheels of the motor vehicle, a computation means for determining, from the angular velocity of at least a part of the plurality of wheels of the motor vehicle, a signal indicative of a first value of the heading of the motor vehicle, and a second sensor module generating a signal indicative of a second value of the heading of the motor vehicle,
the pressure monitoring method comprising:
determining the first value of the heading of the motor vehicle and the second value of the heading of the motor vehicle, and
determining an abnormal pressure situation in at least one of the tires of the plurality of wheels of the motor vehicle when the first value of the heading and the second value of the heading are inconsistent.

6. The monitoring method as claimed in claim 5, wherein the second sensor module, generating a signal indicative of the second value of the heading of the motor vehicle, comprises or is associated with a satellite positioning location interface.

7. The monitoring method as claimed in claim 5, wherein the second sensor module, generating a signal indicative of the second value of the heading of the motor vehicle, comprises or is associated with a compass module.

8. The monitoring method as claimed in claim 5, wherein the monitoring system also comprises a pressure sensor in a predetermined wheel or associated with a predetermined wheel of the plurality of wheels of the motor vehicle for transmitting information indicative of the value of the instantaneous pressure in the tire of the predetermined wheel, and that, during the first step of the monitoring method, the value of the instantaneous pressure in the tire of the predetermined wheel is determined.
